(19) United States
(12) Patent Application Publication
(10) Pub. No.: US 2007/0262071 A1
(43) Pub. Date: Nov. 15, 2007

(54) Film heater

(75) Inventors: Jurgen Matzenmuller, Bellamont (DE); Jorg Knuppel, Schwendi (DE); Detlev Gertitschke, Laupheim (DE)

Correspondence Address: K.F. ROSS P.C., 5683 RIVERDALE AVENUE, SUITE 203 BOX 900, BRONX, NY, 10471-0900, US

(73) Assignee: UHLMANN Pac-Systeme GmbH & Co. KG

(21) Appl. No.: 11/803,147

(22) Filed: May 11, 2007

(30) Foreign Application Priority Data
May 11, 2006 (DE) 102006022263.6-16

(51) Int. Cl. A21B 1/00

(52) U.S. Cl. 219/405

(57) ABSTRACT

An apparatus for heating a thermoplastic film moving along a path has a radiant heater to one side and generally above the path directed at the film so that the heater heats the passing film, a reflector to an opposite side and generally below the path opposite the heater, and a coller connected to the reflector for cooling it to a temperature below a melting point of the film.

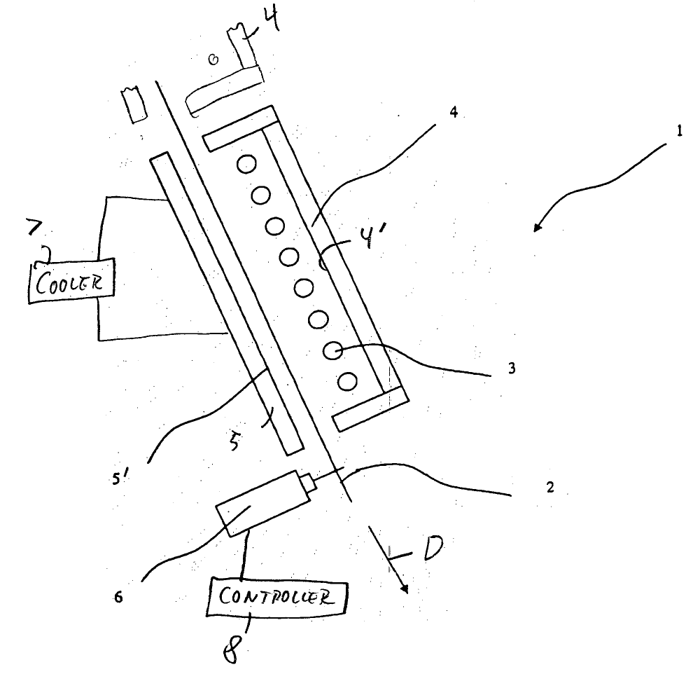

### FIELD OF THE INVENTION

The present invention relates to a heater. More particularly this invention concerns an apparatus for heating a continuously passing thermoplastic film, as in a thermoshaping or packing operation.

### BACKGROUND OF THE INVENTION

In various packaging and manufacturing operations, it is necessary to heat a thermoplastic sheet or film (hereinafter referred to simply as a film) to a point where it can be subsequently shaped. For instance it is standard to do this before gripping the film between a pair of vacuum-shaping dies to form it with pockets that are subsequently filled with, for instance, pills, then another film or a metal foil is adhered atop the pocket-forming film, and the resultant laminate is cut into individual packages.

The film heater normally has at least one radiator to one side of the path along which the film passes. This radiator emits thermal radiation, normally infrared. It has a cup-shaped housing open toward the film from one side, and on the opposite side of the film or the path along which it travels, there is a reflector. This reflector directs heat waves passing through or past the film back toward the radiator.

When such heaters are used in thermoforming machines to heat the film to be deformed, in particular in a forming station, to the deformation temperature it is necessary that the heating be performed quickly so as not to limit the travel speed of the film. It is also essential that utmost care be taken by the provision of redundant safety systems to prevent overheating of the film resulting in rupture or burn-through. In the pharmaceutical industry where these devices often work in clean rooms such overheating is even more problematic, since it can result in the generation of toxic gases that contaminate everything in the clean room.

Nonetheless in spite of any efforts taken, a periodic rupture or stopping of the film is going to happen. In this case, even if the radiator is shut off immediately, there is normally enough residual heat to cause the film to sag down and melt onto the reflector and burn completely through. The resultant mess can mean hours or days of downtime for clean up.

### OBJECTS OF THE INVENTION

It is therefore an object of the present invention to provide an improved film heater.

Another object is the provision of such an improved film heater that overcomes the above-given disadvantages, in particular that prevents burn-through or melting of the film even if the film stops or breaks while the radiator is still on.

### SUMMARY OF THE INVENTION

An apparatus for heating a thermoplastic film moving along a path has according to the invention a radiant heater to one side and generally above the path directed at the film so that the heater heats the passing film, a reflector to an opposite side and generally below the path opposite the heater, and means for cooling the reflector to a temperature below a melting point of the film.

Thus according to the invention the film runs between the reflector and the radiator together with the housing at an angle of inclination that is inclined with respect to the vertical, and the reflector is positioned beneath the film. This design provides the particular advantage that even upon failure of the security systems, for which, despite redundant hardware and software security, tearing of the film cannot be ruled out over the entire operating life of the heater, in the event of such a malfunction the film drops onto the cooled reflector so that the interaction of the inclination of the web together with the reflector situated beneath the film provides an increased measure of safety. The reflector offers the additional advantage that the power required for heating the film may be reduced, since the light transmitted through the film is reflected back onto the film.

The efficiency of the heater is further increased by designing the inner surface of the housing as a counter-reflector, so that the light transmitted through the film may be repeatedly reflected back on the film until the radiation energy emitted by the radiator has been essentially fully utilized, i.e. the film has a virtual absorption thickness which extends over its actual thickness. It is also noted that the housing and the reflector essentially completely encapsulate the radiator, so that the operator using the equipment is exposed to a cool outer surface which poses no risk of injury.

High efficiency is achieved when the reflector and/or counter-reflector are coated with a highly reflective layer. For a long service life it is advantageous for the layer to be of gold or silver, for the case of silver a protective layer also being provided to prevent corrosion. With regard to the lightest possible design that still withstands the stresses occurring during operation, the reflector and/or counter-reflector are preferably made of aluminum, preferably polished AlMg₃.

Alternatively, the reflector and/or counter-reflector may also be made of coated glass, like a standard mirror.

In the event of a malfunction, to reliably achieve a drop of the film onto the reflector under the effect of gravity it is advantageous for the angle of inclination to have a value between +45° and −45°, preferably between +15° and −15°. For process control a pyrometer is provided downstream from the housing relative to the direction of travel of the film to measure the film temperature after heating. This temperature measurement is used for process monitoring and control of the radiator. To allow the temperature measurement to be carried out over the entire film width, the pyrometer is adjustable transverse to the direction of travel of the film. To increase the efficiency and thus reduce the exposure time in particular for a continuously running film, a plurality of radiators is provided in a row, parallel to the direction of travel of the film. The radiator is designed as an IR radiant heater having maximum emitted energy at a wavelength between 0.5 μm and 10 μm, thereby optimizing the maximum emitted energy for commonly used plastic films.

### BRIEF DESCRIPTION OF THE DRAWING

The above and other objects, features, and advantages will become more readily apparent from the following description, reference being made to the accompanying drawing whose sole FIGURE is a largely schematic illustration of the present invention.

### SPECIFIC DESCRIPTION

As seen in the drawing a heater 1 for a continuously running thermoforming machine for processing films 2 comprises a plurality of radiators 3, designed as IR radiant heaters and provided in a row inside a housing 4 and parallel to the direction of travel of the film (arrow), which are used for the emission of thermal radiation, thereby heating the film 2 to the deformation temperature to prepare it for deformation in a subsequent forming station. The film 2 moves along a straight path forming an angle of about 15° to the vertical in a direction D.

It is particularly important that a reflector 5 be provided on the side of the film 2 opposite from the radiator 3, and that the web of film 2 run between the reflector 5 and the radiator 3 together with the housing 4 at an angle of inclination that is inclined with respect to the vertical. The angle of inclination has a value between +45° and −45°. The reflector 5 is positioned beneath the film 2. The reflector 5 also is connected to a cooling device 7 so that in the event of a malfunction which could damage or even-tear the film 2, the damaged film sections drop onto the cooled reflector 5 under the effect of gravity, and the reflector 5 provides an increased measure of safety. For normal operation the reflector 5 offers the advantage that reduced power is sufficient to heat the film 2 to the required deformation temperature. The multiple reflection of the thermal radiation emitted by the radiator 3 is facilitated in particular when an inner surface 4′ of the housing 4 is designed as a counter-reflector to the reflective surface 5′ of the reflector 5.

The reflector 5 and/or counter-reflector may be made of aluminum, in particular polished aluminum. A highly reflective layer may be applied as an alternative to enhancing the reflectivity by polishing.

A pyrometer 6 is provided downstream from the housing, relative to the direction of travel of the film. It is connected to a controller 8 that can shut down the emitter 3 if it detects a malfunction. The film 2 being too hot would indicate that it had slowed, and the film 2 being to cool would indicate that it had stopped altogether.

We claim:

1. An apparatus for heating a thermoplastic film moving along a path, the apparatus comprising:
a radiant heater to one side and generally above the path directed at the film, whereby the heater heats the passing film;
a reflector to an opposite side and generally below the path opposite the heater; and
means for cooling the reflector to a temperature below a melting point of the film.

2. The heating apparatus defined in claim 1 wherein the reflector and radiator are both oriented at a small acute angle to the vertical.

3. The heating apparatus defined in claim 1 wherein the heater includes a concave heater shell open toward the path and an emitter in the shell.

4. The heating apparatus defined in claim 3 wherein the emitter emits radiant heat.

5. The heating apparatus defined in claim 3 wherein an inner surface of the shell is reflective.

6. The heating apparatus defined in claim 1 wherein the reflector has a highly reflective face directed generally upward at the film and toward the heater.

7. The heating apparatus defined in claim 6 wherein the reflector face is plated with gold or silver.

8. The heating apparatus defined in claim 6 wherein the reflector face is plated with silver in turn covered by a transparent corrosion-inhibiting coating.

9. The heating apparatus defined in claim 6 wherein the reflector is glass.

10. The heating apparatus defined in claim 1 wherein the reflector has a generally planar face forming an angle of less than 45° to the vertical.

11. The heating apparatus defined in claim 10 wherein the angle is less than 15°.

12. The heating apparatus defined in claim 1 further comprising
a pyrometer juxtaposed with the film downstream of the theater relative to a film-travel direction.

13. The heating apparatus defined in claim 12 wherein the pyrometer is shiftable transverse to the film-travel direction.

14. The heating apparatus defined in claim 1 wherein the emitter is an IR emitter.

15. The heating apparatus defined in claim 14 wherein the IR emitter emits radiation with a wave length between 0.5 μm and 10 μm.

16. The heating apparatus defined in claim 1 wherein the heater includes a plurality of emitters spaced apart in a travel direction of the film.
